(19) United States
(12) Patent Application Publication
(10) Pub. No.: US 2018/0025437 A1
(43) Pub. Date: Jan. 25, 2018

(54) Method and System for Managing Crowdsourced Funds

(71) Applicant: MASTERCARD ASIA/PACIFIC PTE LTD, SINGAPORE (SG)

(72) Inventors: Veronica Kuoh, Singapore (SG); Krishnadas Mohandas, Singapore (SG); Eric Jian Hui Lin, Singapore (SG); Benjamin Charles Gilbey, Singapore (SG)

(21) Appl. No.: 15/656,083

(22) Filed: Jul. 21, 2017

(30) Foreign Application Priority Data
Jul. 22, 2016 (SG) 10201606087U

(51) Int. Cl. G06Q 40/00; G06Q 50/00

(52) U.S. Cl. CPC G06Q 40/12; G06Q 50/01

(57) ABSTRACT

Device and method for managing crowdsourced funds. The method comprises: creating expenditure categories, each of the expenditure categories being linked to a respective category account for obtaining funds from the crowdsourced funds; allocating a percentage of the crowdsourced funds to each of the expenditure categories; applying restrictions on utilization of the allocated percentage to reception parameters imposed upon each of the respective expenditure categories; providing a user interface to display each of the created expenditure categories and the respective percentage allocation of the crowdsourced funds; receiving, through the user interface, a contribution to the crowdsourced funds from a payment network; allocating the received contribution across the expenditure categories by channeling the received contribution to the respective category account in accordance with the reception parameters and the respective allocated percentage; and permitting access to the funds in the category account for transactions that comply with the reception parameters imposed upon the expenditure category linked to the category account.

### CROSS-REFERENCE TO RELATED APPLICATION

This application claims the benefit of and priority to Singapore Patent Application No. 10201606087U, filed Jul. 22, 2016. The entire disclosure of the above application is incorporated herein by reference.

### FIELD

The following discloses a method and system to manage crowdsourced funds.

### BACKGROUND

This section provides background information related to the present disclosure which is not necessarily prior art.

Different means of raising monetary contributions for both commercial and non-commercial causes have emerged over the years wherein one such popular means is crowdfunding. However, crowdfunding platforms, like Kickstarter and Indiegogo, face a unique issue in the area of tracking and controlling the actual spending of the funds raised by the fundraiser.

Specifically, contributors have no visibility on how fundraisers are using the money after the funds are transferred into the fundraiser's bank account. This creates potential gaps that can be exploited by the fundraisers. Incidence of fraud or misappropriation of funds has also been surfacing around the world.

As a whole, the crowdfunding ecosystem operates on the premise of a high level of trust and good faith between contributors and fundraisers. It is the fundraisers' responsibility to complete their project. The platform is not involved or liable in the development of the projects themselves.

Thus, what is needed is a method and system to instate spend management and transparency to improve upon the way in which the crowdfunding system operates such that there is clearer visibility on how fundraisers are using the money after the funds are transferred into the fundraiser's bank account. Furthermore, other desirable features and characteristics will become apparent from the subsequent detailed description and the appended claims, taken in conjunction with the accompanying drawings and this background of the disclosure.

### SUMMARY

This section provides a general summary of the disclosure, and is not a comprehensive disclosure of its full scope or all of its features. Aspects and embodiments of the disclosure are set out in the accompanying claims.

According to a first aspect, there is provided a method of managing crowdsourced funds, the method comprising: creating expenditure categories, each of the expenditure categories being linked to a respective category account for obtaining funds from the crowdsourced funds; allocating a percentage of the crowdsourced funds to each of the expenditure categories; applying restrictions on utilization of the allocated percentage to reception parameters imposed upon each of the respective expenditure categories; providing a user interface to display each of the created expenditure categories and the respective percentage allocation of the crowdsourced funds; receiving, through the user interface, a contribution to the crowdsourced funds from a payment network; allocating the received contribution across the expenditure categories by channeling the received contribution to the respective category account in accordance with the reception parameters and the respective allocated percentage; and permitting access to the funds in the category account for transactions that comply with the reception parameters imposed upon the expenditure category linked to the category account.

According to a second aspect, there is provided a server for an intermediary that facilitates managing crowdsourced funds, the server comprising: at least one processor and at least one memory including computer program code; the at least one memory and the computer program code configured to, with the at least one processor, cause the server at least to: create expenditure categories, each of the expenditure categories being linked to a respective category account for obtaining funds from the crowdsourced funds; allocate a percentage of the crowdsourced funds to each of the expenditure categories; apply restrictions on utilization of the allocated percentage to reception parameters imposed upon each of the respective expenditure categories; provide a user interface to display each of the created expenditure categories and the respective percentage allocation of the crowdsourced funds; receive, through the user interface, a contribution to the crowdsourced funds from a payment network; and allocate the received contribution across the expenditure categories by channeling the received contribution to the respective category account in accordance with the reception parameters and the respective allocated percentage; and permit access to the funds in the category account for transactions that comply with the reception parameters imposed upon the expenditure category linked to the category account.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. With that said, the accompanying figures, where like reference numerals refer to identical or functionally similar elements throughout the separate views and which together with the detailed description below are incorporated in and form part of the specification, serve to illustrate various embodiments and to explain various principles and advantages in accordance with a present embodiment, by way of non-limiting example only.

Embodiments of the present disclosure are described hereinafter with reference to the following drawings, in which:

FIG. 1 shows stages of a process of managing and transacting crowdsourced funds.

FIG. 2 shows a flowchart depicting steps of a method for managing crowdsourced funds.

FIG. 3 shows a schematic of a network-based system which performs the method of managing crowdsourced funds.

FIG. 4 shows a schematic of a computing device used to realise the server shown in FIG. 3.

### DETAILED DESCRIPTION

Embodiments of the present disclosure will be described, by way of example only, with reference to the drawings. The description and specific examples included herein are intended for purposes of illustration only and are not intended to limit the scope of the present disclosure. And again, like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices, such as magnetic or optical disks, memory chips, or other storage devices suitable for interfacing with a computer. The computer readable medium may also include a hard-wired medium, such as exemplified in the Internet system, or wireless medium, such as exemplified in the GSM mobile telephone system. The computer program when loaded and executed on a computer effectively results in an apparatus that implements the steps of the preferred method.

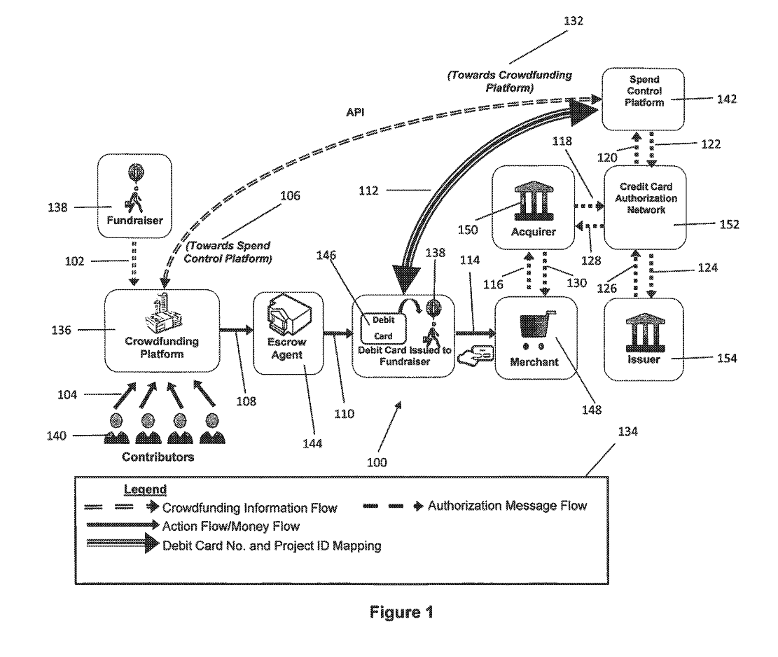

FIG. 1 shows stages of a process 100 of managing and transacting crowdsourced funds. By way of a non-limiting example, the process 100 is illustrated with a crowdfunding platform 136, hereinafter referred to as a “platform”. It can be appreciated that the crowdfunding platform 136 is a non-limiting exemplary means of implementing the process which may also include other forms of fund managing means that bring at least one fundraiser 138 and/or at least one contributor 140 together to launch a cause for initiating the funds to be raised and/or contributed. As used herein, the term “fundraiser” refers to a person who seeks to receive funds for a particular purpose and the term “contributors” refers to people who pledge money to the fundraiser. By way of a non-limiting example, the fundraiser may be a creator or owner of a project who raises funds to bring the project to life and the contributors may be people who pledge money to the fundraiser to kick-start the project. In addition, as used herein, the terms “crowdsourced funds” and “contributed funds” refer to funds that are provided by the contributors to the fundraiser. In one or more implementations, fundraisers that channel funds to the crowdfunding platform 136 may gain from the provision of such funds, for example, by receiving a service or a product, equity in the project, or a monetary return. For the sake of simplicity, only one fundraiser 138 is considered in the description but it can be understood that the platform can host more than one fundraiser.

To aid in comprehension and understanding of the present disclosure, FIG. 1 legend 134 defines types of transaction flow for each stage of the abovementioned process. The informational flow comprises crowdfunding information flow, action and/or money flow, authorization message flow and debit card number and project identity (ID) mapping.

At stage 102, the platform 136 may allow the fundraiser 138 to create new projects and collect contributions for the new projects while the contributors 140 may browse for existing projects and pledge to the new projects by contributing monetary amounts. This may involve the fundraiser 138 inputting and submitting various data fields into the platform 136. This application may be hosted on a web portal, which the fundraiser 138 and contributors 140 may access through an internet browser. Alternatively, this application may be installed in the contributors' 140 mobile device, such as a tablet or a mobile phone. In either implementation, the fundraiser 138 and contributors 140 can perform the abovementioned corresponding actions.

By inputting the project information into the various data fields on the platform 136, the project information may be processed and, subsequently, the project information may be displayed on the platform 136 which may include but are not limited to project description, pledge information and project funds. In this regard, the projected funds may also comprise funds that are raised and the pledge information may also comprise a clear breakdown on how the project funds are going to be used at a start of a campaigning period on the platform 136. The data field may be implemented through the means of a text field, a drop-down menu, a check box, an image data field or any other suitable user interface form elements for inputting textual and graphical images by the fundraiser. The user interface form elements may also comprise a reset and/or a submit button. A list of expenditure categories may then be created. Each expenditure category may be an expense belonging to an activity, or a group of expenses belonging under the activity that is required to support the project for which the crowdsourced funds are being raised. Examples of expenditure categories include payroll, advertising, equipment and cash withdrawals to cover miscellaneous costs. Expenses which fall under the payroll expenditure category include salary for the fundraiser 138, the staff the fundraiser 138 employs and charges for engaging agents for outsourced work. Expenses which fall under the advertising expenditure category include payments to traditional media (such as newspapers and magazines) and electronic media (like websites). Expenses which fall under the equipment expenditure category include office furniture, computer hardware and software. Expenses of miscellaneous cost that the cash withdrawal expenditure category covers include petty cash withdrawal, food and transport reimbursement.

The expenditure categories may be maintained in accordance to the breakdown of how the project funds are being raised. This advantageously serves as a control limit instated in each expenditure category based on the monetary amount of the contributed funds. Each of the expenditure categories is linked to a respective category account which holds the funds for its expenditure category. The linkage allows each of the expenditure categories access to the crowdsourced funds, i.e. the linkage provides a means for the crowdsourced funds to be channeled to each of the expenditure categories. In one embodiment, the expenditure accounts are separate accounts, making the expenditure categories independent to one another. The independence may be such that if the funds in one expenditure category are exhausted, they cannot be replenished using funds from another expenditure category.

Each of the expenditure categories is funded through allocation of a percentage of the crowdsourced funds. Restrictions on utilization of the allocated percentage may be applied, these restrictions being in accordance to reception parameters imposed upon each of the respective expenditure categories. Reception parameters are one or more rules ensuring that funds drawn from an expenditure category are spent on legitimate expenses, i.e. expenses that belong to activities that fall under the respective expenditure category. Accordingly, the reception parameters of one expenditure category may be different from the reception parameters of another expenditure category.

The expenditure categories may then be mapped to specific transaction codes such that any transaction made by the fundraiser 138 can be tracked. The transaction may comprise any contributed funds utilized by the fundraiser 138, any funds being made by the contributors 140, any monetary interest being accrued in the contributed funds or any other actions by the fundraiser 138, contributors 140 or any other parties which can change the monetary amount of the contributed funds. Mapping of the expenditure categories to specific transaction codes may include non-limiting examples as follow:
Prototyping/material expenditure category which is mapped to a specific merchant category code
Third party service expenditure category which is mapped to another specific merchant category code
Payroll/staffing expenditure category which is mapped to yet another specific merchant category code
Miscellaneous cash amount expenditure category which is mapped to a cash withdrawal code

At stage 104, based on the project information provided by the fundraiser 138, contributors 140 may have a clear visibility on the proposed breakdown of fund usage for the project on the platform 136. As such, this advantageously aids the contributors 140 in their decision making process before a monetary amount is committed.

The contributors 140 may then provide a contributed amount from various payment means through the platform 136. This contributed amount will be received through the user interface of the platform 136 from a payment network. A non-limiting example would be a checkout or shopping cart system wherein this implementation may be additionally facilitated with a four party network system used by Visa® or MasterCard® to process a payment transaction made using their card. Another non-limiting example of contributing money may be through a prepaid credit system wherein the contributors 140 may contribute a monetary amount from prepaid credits purchased while the fundraiser 138 may be credited with the contributed monetary amount thereafter. Further to the aforementioned, it can be understood that various alternative payment means can be implemented by the platform 136. The contributed amount will then add on to the pool of the crowdsourced funds managed by the platform 136.

The user interface of the platform 136 may also provide a plurality of fields, which include a general contribution field that distributes the received contribution across the expenditure categories in accordance with the respective allocated percentage and a specific contribution field that allocates the received contribution to a selected one of the expenditure categories. The plurality of fields are data fields that can be inputted by means of a text field, a drop-down menu, a check box, an image data field or any other suitable user interface form elements for inputting textual and graphical images by the contributors. The user interface form elements may also comprise a reset and/or a submit button.

Stage 106 denotes an end of the campaign period, where a total contribution fund may then be tabulated. Based on the percentage allocation for each expenditure category and the total contribution funds which are tabulated, a monetary limit for each expenditure category may then be calculated.

The monetary limit for each expenditure category may be performed by an algorithm running in spend control platform 142. In one implementation, the spend control platform 142 and the crowdfunding platform 136 are both programming modules operated within the same server, with the crowdfunding platform 136 module being at the front-end through its provision of the user interface and the spend control platform 142 being at the back-end processing the input made at the user interface. In another implementation, the spend control platform 142 and the crowdfunding platform 136 are operated by separate servers. Information which comprises the percentage allocation for each expenditure category and the total monetary amount being contributed may be fed to the algorithm of the spend control platform 142. The reception parameters that are imposed on each of the expenditure categories may be configured by the spend control platform 142 algorithm. These reception parameters may be pre-determined, i.e. they can be preconfigured in the control spend platform 142 and are independent of the amount of received crowdsourced funds.

Alternatively, the reception parameters may factor the amount of received crowdsourced funds. For example, the fundraiser 138 may only utilize the contributed funds for expenditure A) within the list of expenditure categories and B) within the calculated monetary limit for each expenditure category in the list of expenditure categories.

As an additional example, configuration of the reception parameters may also comprise factoring in the purpose or cause of the project for which the crowdsourced funds are raised. If the project initiated by the fundraiser 138 is for profit, the reception parameters may be configured to reserve a portion of the funds in each of the expenditure categories to serve as profit for the fundraiser 138 upon completion and delivery of the project. If the project initiated by the fundraiser 138 is for non-profit, the reception parameters may be configured to have the balance of funds in each of the expenditure categories donated to a charitable organization determined by the contributors 140 upon completion and delivery of the project. It can be understood that various alternative reception parameters can be implemented by the spend control platform 142.

Furthermore, by way of a non-limiting example, information may be fed to the spend-control platform 142 via an Application Program Interface (API) from the platform 136 as shown in FIG. 1. Notwithstanding the aforementioned, it can also be understood that any other means can be implemented to facilitate the information flow between the spend-control platform 142 and the platform 136.

At stage 108, the overall funds raised can be transferred to a trust account being held by an escrow agent 144. This trust account may comprise a ledger for all of the category accounts, each linked to a respective expenditure category. Alternatively, the trust account may comprise a master account that draws from each of the category accounts. The escrow agent 144 may be an Internet escrow or any other applicable type of escrow (depending on the compatibility of the platform 136 and/or the preference of fundraiser's 138) which can provide necessary fiduciary responsibilities to be entrusted with the contributed funds.

The received contribution is allocated across the expenditure categories, maintained at the escrow agent 144, by channeling the received contribution to the respective category account in accordance with the reception parameters and the respective allocated percentage. Transactions which seek access to the funds in each of the category accounts may be screened by the spend control platform 142 to ensure that they comply with the reception parameters imposed upon the expenditure category linked to the category account before the access is permitted.

At stage 110, the escrow agent 144 can issue one or more payment instruments 146 linked to the trust account of the fundraiser 138. In the implementation where there is a master account that draws from each of the category accounts, only one payment card may be used to access the received crowdsourced funds through the master account. In the implementation where each category account is linked to a payment instrument, there may be one or more payment cards. Although the payment instrument is illustrated by way of an example of a debit card in FIG. 1, other non-limiting examples of the payment instrument can include a credit card, a charge card, a stored-value card, a gift card, and a pre-paid card. As such, as used herein, the terms “payment instrument” and “payment card” refer to any suitable transaction means, such as a credit card, a debit card, a prepaid card, a charge card, a membership card, a promotional card, an identification card, a gift card, and/or any other device that may hold payment account information, such as mobile phones, smartphones, personal digital assistants (PDAs), key fobs, and/or computers. Each type of payment instrument 146 may be used as a method of payment for performing a transaction. The payment instrument may be mapped 112 to a unique project identity (ID) on the spend-control platform 142 such that any transaction made by the fundraiser 138 can be linked to the specific project initiated by the fundraiser 138 and reflected on the platform 136 and the spend-control platform 142. In addition, the rules set by the above mentioned reception parameters may also be instated to the payment instrument 146 by the spend-control platform 142.

At stage 114, the fundraiser 138 makes a purchase with the payment instrument 146 at a merchant 148. Typically, in a “card-present” electronic payment instrument transaction, when the fundraiser 138 wishes to purchase a product from the merchant 148, the fundraiser 138 presents his/her payment card (or payment instrument) to the merchant 148. The merchant 148 typically has a point-of-sale (POS) terminal with a card reader that can interact/communicate with the payment card and facilitates the conduct of the electronic payment transaction.

At stage 116, the merchant 148 can forward a request to the acquirer 150 (a financial institution that processes and settles the merchant's transactions with the help of an issuer 154). The authorization request can then be forwarded to an Authorization Network 152 as shown in stage 118. Triggering of stages 116 and 118 can be through specific bank identification numbers belonging to the payment instrument 146. At stage 120, the Authorization Network 152 can then forward the authorization request to the spend control platform 142 for execution in accordance to the control rules and limits of the reception parameters imposed upon each of the expenditure categories. If the purchase is not approved according to the control rules and limit at stage 122, the authorization can be rejected by the spend-control platform 142 and the fundraiser 138 is not able to proceed with the purchase. Otherwise, the authorization request can be approved and forwarded to the issuer 154 at stage 124. At stage 126, if the purchase is made at a pre-approved merchant category and is within the stipulated aggregated spend limit for that expenditure category, the issuer 154 can then approve the Authorization Request and send it back to the Authorization network 152. The Authorization network 152 returns the response to the acquirer 150 at stage 128 and the acquirer 150 forwards this response to the merchant 148 at stage 130. The transaction can then be authorized and the purchase can now be processed. Funds from the trust account, maintained by the escrow agent 144, will thus be debited.

At stage 132, the spend-control platform 142 can also track in real time how the funds are being utilized, communicating the actual expenditure by the fundraiser 138 back to the platform 136. Thereafter, the actual expenditure can be displayed on a real-time dashboard, in the user interface provided by the crowdfunding platform 136, which advantageously grants full visibility of the actual expenditure to the contributors 140.

In one implementation, the process 100 may comprise an additional stage (not shown in FIG. 1) involving the fundraiser 138 appealing to adjust the control rules and limits of the reception parameter imposed by the spend-control platform 142 wherein the outcome of the appeal is subjected to approvals from a substantial number of the contributors 140. In this context, the substantial number of contributors 140 can refer to any predetermined number of contributors 140 set by the spend control platform 142, ranging in any percentages between 50 to 100 percent of the total number of contributors 140.

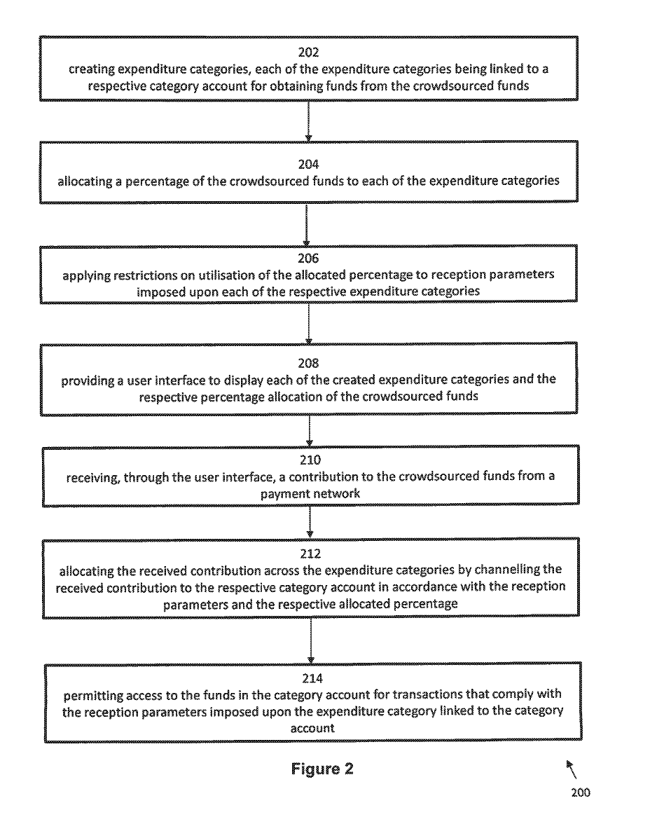

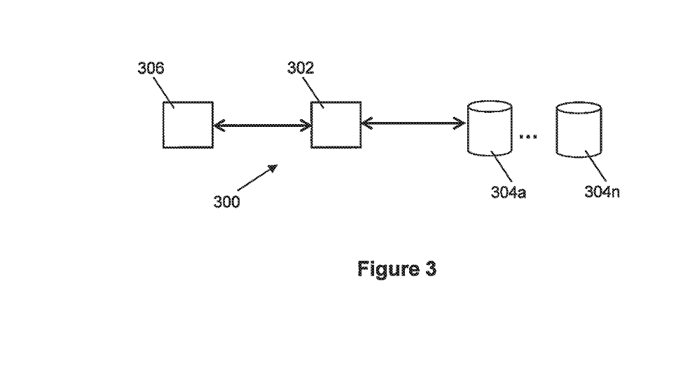

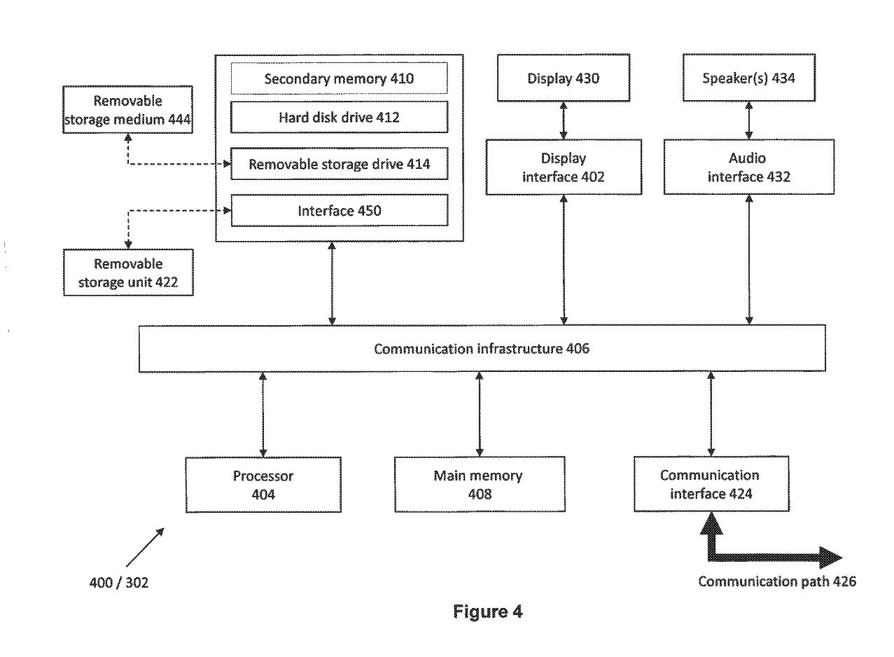

FIG. 2 shows a flowchart depicting steps of a method 200 for managing funds according to an example embodiment. The method 200 may be utilized by the platform 136 and/or the spend control platform 142 in FIG. 1 and may also be performed by a purpose-built computer server device that is coupled to a database. Further details on the purpose-built computer server device will be provided below with reference to FIGS. 3 and 4.

The method 200 can comprise a first step 202 of creating expenditure categories, each of the expenditure categories being linked to a respective category account for obtaining funds from the crowdsourced funds. Creation of the expenditure categories may involve the expenditure categories being created based on predetermined information provided by the fundraiser 138 with regards to the breakdown on how the projected funds are going to be used in accordance to stage 102 of FIG. 1 as described above. Also, as mentioned above in stage 102 of FIG. 1, the expenditure categories may be mapped to specific transaction codes. The expenditure category may then be maintained by the spend control platform 142 in accordance to stage 106 of FIG. 1, as described above.

A second step 204 allocates a percentage of the crowdsourced funds to each of the expenditure categories. A third step 206 applies restrictions on utilization of the allocated percentage to reception parameters imposed upon each of the respective expenditure categories. Thereafter, a fourth step 208 involves providing a user interface to display each of the created expenditure categories and the respective percentage allocation of the crowdsourced fund. The expenditure category may be displayed in a graphical, textual or any other form of representations comprehensible by the contributors 140. Additionally, changes to the expenditure category may be reflected in real-time or refresh periodically.

The fifth step 210 involves receiving, through the user interface, a contribution to the crowdsourced funds from a payment network. This may involve extracting information from a fund contribution platform which may reside within or externally coupled to the platform 136. The sixth step 212 involves allocating the received contribution across the expenditure categories by channeling the received contribution to the respective category account in accordance with the reception parameters and the respective allocated percentage. The steps 202 and 212 advantageously provide clearer visibility for the contributors 140 on how the crowdsourced funds are distributed and used by the fundraiser 138, respectively. Finally, the last step 214 permits access to the funds in the category account for transactions that comply with the reception parameters imposed upon the expenditure category linked to the category account.

The method 200 can further comprise an additional step (not shown in FIG. 2) of configuring the user interface to provide a contribution indicator, a reserve indicator and a distribution indicator for each of the displayed expenditure categories. In this regard, the contribution indicator can show a total of the received contributions provided by the contributors 140 at any instance while the reserve indicator can show a remainder or balance of the crowdsourced funds after being utilized by the fundraiser 138 or further contributed by at least one contributor 140. In addition, the distribution indicator for each of the displayed expenditure categories can show an amount accumulated into each of the displayed expenditure categories which can be updated when there is a change in the monetary amount accumulated into each of the displayed expenditure categories. The change in the monetary amount may be reflected whenever a monetary amount is utilized by the fundraiser 138 or contributed by the contributors 140 in at least one expenditure category. Information for the contribution, reserve and distribution indicators may be extracted from the fund contribution system and spend control platform 142. Similarly, the contribution, reserve and distribution indicators may be displayed in a graphical, textual or any other form of representations comprehensible by the contributors 140. In addition, information displayed by the aforementioned indicators may be reflected in real-time or refresh periodically. As such, providing the aforementioned indicators advantageously provides further transparency to the contributors 140 as the contributors 140 will be able to view how the crowdsourced funds are used by the fundraiser 138.

Furthermore, the method 200 can also comprise configuring the user interface on the platform 136 and/or the spend control platform 142 to provide a plurality of fields to receive the contribution to the crowdsourced funds in accordance to stage 102 of FIG. 1, as described above. The plurality of fields can include a general contribution field that distributes the received contribution across the expenditure categories in accordance with the respective allocated percentage and a specific contribution field that allocates the received contribution to a selected one of the expenditure categories. These fields advantageously provide better flexibility options for the contributors 140 to contribute funds.

The reception parameters imposed upon each of the respective expenditure categories of step 206 can comprise configuring a set of rules that restrict the expenditure category to transactions falling within its designated category based on the percentile breakdown for each expenditure category as indicated by the fundraiser 138 and the total contributed funds fed in accordance to stage 106 of FIG. 1, as described above. The method 200 can also further comprise steps in accordance to stages 106, 108 and 110 of FIG. 1 wherein the method 200 involves the steps of allocating an identity used to identify the crowdsourced funds and designating an account for storing the crowdsourced funds. Essentially, the account can be referenced through the use of this identity. With reference to stage 110 of FIG. 1, as described above, the aforementioned identity may be the project identity and access to the crowdsourced funds in the account can be executed by a payment instrument 146 linked to the account wherein the payment instrument 146 belongs to a reserved bank identification number (BIN) range. Furthermore, expenditures made on the payment instrument 146 are restricted by the reception parameters set on each of the expenditure categories as described in stage 110.

The method 200 can also determine a classification from which an expenditure made on the payment instrument 146 belongs and provide access to the crowdsourced funds stored in the account in response to successful verification of the classification falling within one of the designated categories of the expenditure categories, as described above in stages 116 to stages 130 of FIG. 1.

FIG. 3 shows a schematic of a network-based system 300 which performs the method of managing crowdsourced funds. The network-based system 300 may comprise at least one purpose-built computer server device 302 which serves the processing role of the spend control platform 142 and the platform 136; and one or more databases 304a . . . 304n to store the project information. As such, the purpose-built computer server device 302, hereinafter referred to as a “fund management server”, may host the spend control platform 142 and/or the platform 136. In addition, the fund management server 300 also comprises an I/O module 306 for inputting information into and outputting information from a network-based system 300.

Each of the one or more databases 304a . . . 304n can be communicatively coupled with the fund management server 302. The user output module 306 may be a separate and distinct module that is communicatively coupled with the fund management server 302.

The fund management server 302 can further comprise: at least one processor; and at least one memory including computer program code; the at least one memory and the computer program code can be configured to, with at least one processor, cause the fund management server 302 to at least perform the method 200. The fund management server 302 is thus configured to: A) create expenditure categories, each of the expenditure categories being linked to a respective category account for obtaining funds from the crowdsourced funds; B) allocate a percentage of the crowdsourced funds to each of the expenditure categories; C) apply restrictions on utilization of the allocated percentage to reception parameters imposed upon each of the respective expenditure categories; D) provide a user interface to display each of the created expenditure categories and the respective percentage allocation of the crowdsourced funds; E) receive, through the user interface, a contribution to the crowdsourced funds from a payment network; and F) allocate the received contribution across the expenditure categories by channeling the received contribution to the respective category account in accordance with the reception parameters and the respective allocated percentage; and G) permit access to the funds in the category account for transactions that comply with the reception parameters imposed upon the expenditure category linked to the category account.

In one implementation of the fund management server 302, the fund management server 302 can be further configured for the user interface to provide: H) a contribution indicator to show the received contribution; I) a reserve indicator to show a remainder of the crowdsourced funds; and J) a distribution indicator for each of the displayed expenditure categories to show an amount accumulated into each of the displayed expenditure categories.

The fund management server 302 can be further configured to update the distribution indicator when there is a change in the amount accumulated into each of the displayed expenditure categories and provide each of the expenditure categories with a set of rules that restrict the expenditure category to transactions falling within its designated category. The transactions can comprise any one or more of merchant purchases, payroll and cash withdrawals.

The fund management server 302 can be further configured for the user interface to provide a plurality of fields to receive the contribution to the crowdsourced funds, wherein the plurality of fields can comprise a general contribution field that distributes the received contribution across the expenditure categories in accordance with the respective allocated percentage; and a specific contribution field that can allocate the received contribution to a selected one of the expenditure categories.

The fund management server 302 can be further configured to allocate an identity used to identify the crowdsourced funds, wherein the category accounts are referenced through the use of the identity.

The fund management server 302 can be further configured to authorize access to the crowdsourced funds in each of the category accounts. In one approach, the access can be requested from use of a payment instrument 146 linked to the respective category account. In another approach, the access to the crowdsourced funds is through a payment instrument linked to a master account that draws from each of the category accounts.

The fund management server 302 can be further configured to restrict expenditures made on the payment instrument 146 using the reception parameters set on each of the expenditure categories and to verify that the payment instrument 146 belongs to a reserved bank identification number (BIN) range.

The server is further configured to determine a classification under which expenditure can be made on the pertaining payment instrument 146; and permitting access to the crowdsourced funds stored in the category account in response to successful verification of the classification falling within the reception parameters imposed upon the category account.

FIG. 4 depicts an exemplary computing device 400, hereinafter interchangeably referred to as a computer system 400, where one or more such computing devices 400 may be used to execute the method of FIGS. 1 and 2. The exemplary computing device 400 can be used to implement the fund management server 302 shown in FIG. 3. The following description of the computing device 400 is provided by way of example only and is not intended to be limiting.

As shown in FIG. 4, the example computing device 400 includes a processor 404 for executing software routines. Although a single processor is shown for the sake of clarity, the computing device 400 may also include a multi-processor system. The processor 404 is connected to a communication infrastructure 406 for communication with other components of the computing device 400. The communication infrastructure 406 may include, for example, a communications bus, cross-bar, or network.

The computing device 400 further includes a main memory 408, such as a random access memory (RAM), and a secondary memory 410. The secondary memory 410 may include, for example, a storage drive 412, which may be a hard disk drive, a solid state drive or a hybrid drive and/or a removable storage drive 414, which may include a magnetic tape drive, an optical disk drive, a solid state storage drive (such as a USB flash drive, a flash memory device, a solid state drive or a memory card), or the like. The removable storage drive 414 reads from and/or writes to a removable storage medium 444 in a well-known manner. The removable storage medium 444 may include magnetic tape, optical disk, non-volatile memory storage medium, or the like, which is read by and written to by removable storage drive 414. As will be appreciated by persons skilled in the relevant art(s), the removable storage medium 444 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 450. Examples of a removable storage unit 422 and interface 450 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 422 and interfaces 450 which allow software and data to be transferred from the removable storage unit 422 to the computer system 400.

The computing device 400 also includes at least one communication interface 424. The communication interface 424 allows software and data to be transferred between computing device 400 and external devices via a communication path 426. In various embodiments of the disclosures, the communication interface 424 permits data to be transferred between the computing device 400 and a data communication network, such as a public data or private data communication network. The communication interface 424 may be used to exchange data between different computing devices 400 which such computing devices 400 form part of an interconnected computer network. Examples of a communication interface 424 can include a modem, a network interface (such as an Ethernet card), a communication port (such as a serial, parallel, printer, GPIB, IEEE 1394, RJ45, USB), an antenna with associated circuitry, and the like. The communication interface 424 may be wired or may be wireless. Software and data transferred via the communication interface 424 are in the form of signals which can be electronic, electromagnetic, optical or other signals capable of being received by communication interface 424. These signals are provided to the communication interface via the communication path 426.

As shown in FIG. 4, the computing device 400 further includes a display interface 402 which performs operations for rendering images to an associated display 430 and an audio interface 432 for performing operations for playing audio content via associated speaker(s) 434.

As used herein, the term “computer program product” may refer, in part, to removable storage medium 444, removable storage unit 422, a hard disk installed in storage drive 412, or a carrier wave carrying software over communication path 426 (wireless link or cable) to communication interface 424. Computer readable storage media refers to any non-transitory, non-volatile tangible storage medium that provides recorded instructions and/or data to the computing device 400 for execution and/or processing. Examples of such storage media include magnetic tape, CD-ROM, DVD, Blu-Ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card, such as a PCMCIA card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites, and the like.

The computer programs (also called computer program code) are stored in main memory 408 and/or secondary memory 410. Computer programs can also be received via the communication interface 424. Such computer programs, when executed, enable the computing device 400 to perform one or more features of embodiments discussed herein. In various embodiments, the computer programs, when executed, enable the processor 404 to perform features of the above-described embodiments. Accordingly, such computer programs represent controllers of the computer system 400.

Software may be stored in a computer program product and loaded into the computing device 400 using the removable storage drive 414, the storage drive 412, or the interface 450. The computer program product may be a non-transitory computer readable medium. Alternatively, the computer program product may be downloaded to the computer system 400 over the communications path 426. The software, when executed by the processor 404, causes the computing device 400 to perform functions of embodiments described herein.

It is to be understood that the embodiment of FIG. 4 is presented merely by way of example. Therefore, in some embodiments, one or more features of the computing device 400 may be omitted. Also, in some embodiments, one or more features of the computing device 400 may be combined together. Additionally, in some embodiments, one or more features of the computing device 400 may be split into one or more component parts. The main memory 408 and/or the secondary memory 410 may serve(s) as the processor of the fund management server 302 mentioned above; while the processor 404 may serve as the processor of the fund management server 302 mentioned above, configuring the fund management server 302 with the features A) to J) as described above.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

With that said, and as described, it should be appreciated that one or more aspects of the present disclosure transform a general-purpose computing device into a special-purpose computing device when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of managing crowdsourced funds, the method comprising:
creating expenditure categories, each of the expenditure categories being linked to a respective category account for obtaining funds from the crowdsourced funds;
allocating, by a computer server device, a percentage of the crowdsourced funds to each of the expenditure categories;
applying, by the computer server device, restrictions on utilization of the allocated percentage to reception parameters imposed upon each of the respective expenditure categories;
providing a user interface to display each of the created expenditure categories and the respective percentage allocation of the crowdsourced funds;
receiving, through the user interface, a contribution to the crowdsourced funds from a payment network;
allocating, by the computer server device, the received contribution across the expenditure categories by channeling the received contribution to the respective category account in accordance with the reception parameters and the respective allocated percentage; and
permitting access to the funds in the category account for transactions that comply with the reception parameters imposed upon the expenditure category linked to the category account.

2. The method of claim 1, further comprising:
configuring the user interface to provide;
a contribution indicator to show a total of the received contribution;
a reserve indicator to show a remainder of the crowdsourced funds; and
a distribution indicator for each of the displayed expenditure categories to show an amount accumulated into each of the displayed expenditure categories.

3. The method of claim 2, further comprising updating the distribution indicator for a change in the amount accumulated into each of the displayed expenditure categories.

4. The method of claim 1, further comprising configuring the user interface to provide a plurality of fields to receive the contribution to the crowdsourced funds, wherein the plurality of fields include:
a general contribution field that distributes the received contribution across the expenditure categories in accordance with the respective allocated percentage; and
a specific contribution field that allocates the received contribution to a selected one of the expenditure categories.

5. The method of claim 1, further comprising allocating an identity used to identify the crowdsourced funds;
wherein the category accounts are referenced through use of the identity.

6. The method of claim 1, wherein access to the crowdsourced funds in each of the category accounts is through a payment instrument linked to the respective category account.

7. The method of claim 1, wherein access to the crowdsourced funds is through a payment instrument linked to a master account that draws from each of the category accounts.

8. The method of claim 7, wherein expenditure made on the payment instrument is restricted by the reception parameters imposed upon each of the expenditure categories.

9. The method of claim 8, wherein the payment instrument belongs to a reserved bank identification number (BIN) range.

10. The method of claim 7, wherein permitting access to the funds in the category account comprises:
determining a classification under which expenditure made on the payment instrument belongs; and
permitting the access to the crowdsourced funds stored in the category account in response to successful verification of the classification falling within the reception parameters imposed upon the category account.

11. (canceled)

12. A server for an intermediary that facilitates managing crowdsourced funds, the server comprising:
at least one processor; and
at least one memory including computer program code;
the at least one memory and the computer program code configured to, with the at least one processor, cause the server at least to:
create expenditure categories, each of the expenditure categories being linked to a respective category account for obtaining funds from the crowdsourced funds;
allocate a percentage of the crowdsourced funds to each of the expenditure categories;
apply restrictions on utilization of the allocated percentage to reception parameters imposed upon each of the respective expenditure categories;
provide a user interface to display each of the created expenditure categories and the respective percentage allocation of the crowdsourced funds;
receive, through the user interface, a contribution to the crowdsourced funds from a payment network;
allocate the received contribution across the expenditure categories by channeling the received contribution to the respective category account in accordance with the reception parameters and the respective allocated percentage; and
permit access to the funds in the category account for transactions that comply with the reception parameters imposed upon the expenditure category linked to the category account.

13. The server of claim 12, wherein the server is further configured for the user interface to provide:
a contribution indicator to show a total of the received contribution;
a reserve indicator to show a remainder of the crowdsourced funds; and
a distribution indicator for each of the displayed expenditure categories to show an amount accumulated into each of the displayed expenditure categories.

14. The server of claim 13, wherein the server is further configured to update the distribution indicator for a change in the amount accumulated into each of the displayed expenditure categories.

15. The server of claim 12, wherein the server is further configured for the user interface to provide a plurality of fields to receive the contribution to the crowdsourced funds, wherein the plurality of fields comprise:
a general contribution field that distributes the received contribution across the expenditure categories in accordance with the respective allocated percentage; and
a specific contribution field that allocates the received contribution to a selected one of the expenditure categories.

16. The server of claim 12, wherein the server is further configured to allocate an identity used to identify the crowdsourced funds, the identity used to reference the expenditure accounts.

17. The server of claim 12, wherein the server is further configured to authorize access to the crowdsourced funds stored in each of the category accounts, the access being requested from use of a payment instrument linked to the respective category account.

18. The server of claim 12, wherein the server is further configured to authorize access to the crowdsourced funds, the access being requested from use of a payment instrument linked to a master account that draws from each of the category accounts.

19. The server of claim 18, wherein the server is further configured to restrict expenditure made on the payment instrument using the reception parameters imposed upon each of the expenditure categories.

20. The server of claim 19, wherein the server is further configured to verify that the payment instrument belongs to a reserved bank identification number (BIN) range.

21. The server of claim 17, wherein permitting access to the funds in the category account comprises:
determine a classification under which expenditure made on the payment instrument belongs;
provide the access to the crowdsourced funds stored in the category account in response to successful verification of the classification falling within the reception parameters imposed upon the category account.

22. (canceled)
